(19) United States
(12) Patent Application Publication
(10) Pub. No.: US 2009/0225983 A1
(43) Pub. Date: Sep. 10, 2009

(54) SYSTEM AND METHOD FOR IMPROVED PROCESSING AND DECODING OF AN ENCRYPTED DIGITAL VIDEO SIGNAL

(76) Inventors: Ramiro Reinoso, Holland, PA (US); Robert Lukach, Hillsborough, NJ (US)

Correspondence Address: Law Offices of David Schreiber, 825 Third Ave, 2nd Floor, New York, NY, 10022, US

(21) Appl. No.: 12/261,199

(22) Filed: Oct. 30, 2008

Related U.S. Application Data
(60) Provisional application No. 60/984,057, filed on Oct. 31, 2007.

(51) Int. Cl. H04N 7/167; G06F 15/16

(52) U.S. Cl. 380/212; 709/231

(57) ABSTRACT

A method, system, and apparatus for processing a data stream having both unencrypted and encrypted portions for storing, in the unencrypted portion of the data stream, location data signifying the location of predetermined data present in the encrypted portion of the data stream allowing efficient location of said predetermined data.

### RELATED U.S. APPLICATION DATA

This application claims the benefit of U.S. Provisional Application No. 60/984,057, filed Oct. 31, 2007.

### BACKGROUND OF THE INVENTION

1. Field of the Invention

Generally, the invention is directed to the improved location and recognition of encrypted information in a video stream. More particularly, the invention is directed to a method and system for locating certain scrambled or encrypted portions of a video stream and storing the location of such encrypted portion in an unencrypted portion of the video stream to facilitate the efficient location and use of such encrypted portion in a timely manner.

2. Description of the Related Art

Currently, video signals are transmitted to viewers in a number of ways. Examples, include cable, over-the-air antenna and satellite. Recently, service providers have begun to offer television in new manners including internet protocol television (IPTV) which allows the service provider to send audio and video over internet protocol (IP) networks such as the Internet. In addition, more and more television programming is being transmitted in an encrypted manner in order to prevent theft or unauthorized access to the programming. A set-top box or other form of authorization device receives the video signal, de-encrypts and then decodes only those streams which are authorized for that particular viewer.

For example and without limiting the scope of the invention, a video signal may currently be encoded and encrypted in accordance with FIGS. 1-3 which show a typical video stream being processed through an IPTV system. However, the subject invention pertains to other video distribution environments, as well, wherein certain portions of the video signal are being encrypted, such as, for example, cable or satellite distribution.

In this example, the video stream is being encoded using Moving Picture Experts Group (MPEG) standard MPEG-4 AVC, also known as H.264. Other forms of encoding are known, including MPEG-2 or MPEG-4, part 2 and can be used as well. The encoding prepares the video signal for output in a particular format in addition to compressing the video in order to reduce storage space, processor capacity and transmission bandwidth limitations.

In FIG. 1, video stream 100 is transmitted to an encoder 110 which consists of an encoder module 120 which formats video stream 100 and compresses the digital video stream 100 using the MPEG-4 AVC standard. The encoder module 120 generates packetized elementary stream (PES) packets 130 which are transmitted to multiplexer 140 which combines the video with other multimedia content, such as audio, and formats the PES packets 130 into MPEG-2 transport stream (TS) packets (more fully described in ISO/IEC standard 13818-1 and hereinafter referred to as “TS packets”) to prepare video 100 stream for further transport. Other encoding standards and transport stream protocols exist so the MPEG-4 AVC encoding and the MPEG-2 transport stream protocol are only being used for example and not to limit the scope of the invention. TS packets 150 are transmitted to IP Packetizer 160 which groups seven (7) TS packets 150 into a single UDP/IP (User Datagram Protocol/Internet Protocol) packet 170 to further format the video signal for efficient signal flow through an IP network.

UDP/IP packets 170 are then transmitted in a manner appropriate for how the video signal will ultimately be delivered to a viewer. In the current example, the UDP/IP packets are encrypted before transmission to a viewer. Reference is made to FIG. 2 wherein UPD/IP packets 170 are sent to scrambler 200 which includes: a de-encapsulation unit 210 which de-encapsulates the UDP/IP packets 70 back to an TS packets 150 and demultiplexer 220 which de-multiplexes the TS packets 150 into PES packets 130. Scrambler module 230 encrypts PES packets 130 using one of a number of encryption schemes such as DVB-CSA (Digital Video Broadcasting-Common Scrambling Algorithm or AES (Advanced Encryption Standard). Encrypted PES packets 240 are re-multiplexed by multiplexer module 250 to form encrypted TS packets 260 Finally, encrypted TS packets 260 are re-encapsulated by encapsulation module 270 to form encrypted UDP/IP packets 280 for encrypted distribution through an IPTV system wherein the signal is ultimately received, de-encrypted (if such viewer is authorized to view such video stream) and decoded by a set-top box or other similar device and then viewed by the end user via a television or other device (e.g. computer).

FIG. 3A illustrates the structure of several PES packets 130 which each consist of a PES packet header 131 and a video frame or portion of a frame 132. PES packet header 131 includes information related to video frame 132, including the type of frame and timing information. Video frame 132 includes frames of video in one of three type of encoded frames; namely intra frames (I-frames), predictive frames (P-frames) and bi-directional frames (B-frames). These frames are generated by encoder module 120. I-frames are complete frames of video, while both B-frames and P-frames require a reference I-frame in order to generate a complete frame of video. The use of P and B frames aids in compressing the video stream by requiring much less space since they are not, themselves, complete frames of video without the appropriate reference I-frame.

FIG. 3B illustrates the composition of several TS packets 150. Each TS packet 150 includes a TS header 151 and payload 152 which includes a portion of PES packet 130. PES packet header 131 is only included in such TS packet 150 which includes the initial portion of a particular frame of video. TS packet header 151 includes information related to the payload 152 (e.g. whether it is encrypted) but does not include any information related to the type of video frame (e.g. I-frame, B-frame or P-frame) present in payload 152.

Reference is had to FIG. 3C which shows several TS packets 150 after encryption by scrambler 230. Scrambler 230 encrypts payload 152 but does not encrypt TS header 151 so that encrypted TS packet 350 includes a non-encrypted TS packet header 151 and encrypted payload 152 which includes encrypted PES header 331 and encrypted video frame 332.

There are, a number of features used both by programmers/operators/distributors and viewers which the require the prompt location of I-frames (as opposed to B-frames and P-frames). Currently, since payload 152 is encrypted, delay is introduced into the system since at least a portion of payload 152 (e.g. encrypted PES header 331) would need to be de-encrypted to locate a particular I-frame present in video stream 100.

One such feature is certain digital video recorder (DVR) functionality. A DVR can be located at a viewer location separate from or included in a set-top box or located at a remote location to operate as a network DVR. Such DVRs can record, playback, rewind and fast-forward through video streams. The recorded video stream can be saved in a number of ways including on an integrated hard drive or buffer. In order for a DVR to properly rewind or fast-forward through a program, the DVR needs to locate, access and display only I-frames (as discussed above neither a B-frame nor P-frame will provide a full video frame and the attempted display of a B-frame or P-frame without access to the appropriate reference I-frame could distort or degrade the picture or confuse the set-top box or DVR potentially requiring a reset.

Since all frames, including I-frames, and the locations of such frames are encrypted, the set-top box or DVR would have to de-encrypt every encrypted PES packet header 331 to determine if such corresponding encrypted frame 332 is an I-frame. If the corresponding encrypted frame 332 is not an I-frame, the set-top box will need to de-encrypt the next sequential encrypted PES packet header 331 until it locates an I-frame. This is not feasible from a time and/or processing power perspective and would preclude both DVR fast-forward and rewind capability in an encrypted signal environment.

In addition, another feature, unique to an IPTV system, which requires quick access to I-frames is referred to as “fast channel switching” which allows the viewer to change from one channel to another without undue delay. When a new channel is requested by the viewer, the set-top box must request a new IP stream, and first display an I-frame of that new channel so that an entire picture frame is displayed on the television. Equipment located at an IPTV facility such as a head-end must locate and store I-frames for a multiple of video streams in order to transmit the proper I-frame to the set-top box for de-encryption and decoding. However, since such video streams are encrypted, the head-end equipment must de-encrypt every encrypted PES packet header 331 to determine if such corresponding encrypted frame 332 is an I-frame. If the corresponding encrypted frame 332 is not an I-frame, the head-end equipment will need to de-encrypt the next PES packet header 331 until it locates the proper I-frame. This will lead to perceptible delays when a viewer wishes to change a channel.

The third and fourth examples involved functionality referred to as “ad insertion” and “blackout management”. Ad insertion is the splicing of advertisements into a video stream. The splicing or insertion is performed by a splicer at a distributor location such as a “head end” or control room. It is preferable to insert the advertisement or commercial into the video stream and to return to the video stream from the commercial by displaying an I-frame of the video stream so that when the commercial ends, the set-top box can properly display an entire frame of the video stream as opposed to what could happen (e.g. distorted picture) if the decoder attempts to decode the P or B frame with an inappropriate I-frame, possibly an I-frame from the commercial).

Similarly, blackout management is utilized when a particular program can not be shown to a specific population of viewers creating the need to show an alternative program in its place. For example, certain rules created to protect ratings for local television stations may require a New York Yankee baseball game to only be shown to New York subscribers on a certain local channel thus requiring other channels that may be showing the same game to “black out” the game and provide alternative programming to the New York market. In this case, the distributor must place an alternative program into the video stream before the beginning of the “blacked out programming” but after the programming that precedes the “blacked out programming”. Such splicing or insertion would preferably: (i) begin display of the “alternative program” on an I-frame and (ii) resume original programming (the programming on the same channel that follows the “blacked out program”) on an I-frame once the “alternative program” and/or “blacked out program” are completed. Again, the distributor's program management equipment must locate and transmit I-frames for the same reasons discussed above with respect to “ad insertion”.

For the reasons stated above, there is a need in the art for an efficient and timely way to locate I-frames within an encrypted video signal without de-encrypting portions of the video stream.

### SUMMARY OF THE INVENTION

An embodiment of the invention provides a system and method for locating and recognizing encrypted information in a data stream.

Another embodiment of the invention provides a method of processing a data stream comprising, receiving the data stream which includes a first data portion and a second data portion, locating a data element in said second portion of said data stream and storing the location of the data element in the first portion of the data stream.

A further embodiment of the invention provides a method of processing a data stream comprising: receiving the data stream which includes first and second data portions, the first data portion including data type location information which signifies a location of a predetermined data type located in the second data portion and determining the location of the predetermined data type based on the data type location information.

An additional embodiment of the invention provides a data encoding apparatus, comprising: a processing module for receiving data, the data consisting, at least in part, of a first data portion and a second data portion; a detection module configured to detect a predetermined data type located in the second data portion of the data and an encoding module configured to encode, in the first data portion, the location of the predetermined data type.

A further additional embodiment of the invention provides a data decoding apparatus, comprising: a processing module configured to receive data, the data consisting, at least in part, of a first data portion and a second data portion, the first data portion consisting, in part, of data type location information which signifies a location of a predetermined data type located in the second data portion and a decoding module configured to determine a location of the predetermined data type located in the second data portion utilizing the data type location information.

A still further embodiment of the invention provides a system for processing a video signal, comprising: an encoder configured to: (1) receive the video signal, the video signal, consisting, at least in part, of I-frames, B-frames and P-frames, (2) locate an I-frame in the video signal and (3) store a location of the I-frame; an encryption module configured to receive the video signal and to encrypt the I-frames, B-frames and P-frames; and a decoder configured to receive the encrypted I-frames, B-frames and P-frames and to determine the location of the I-frame by utilizing the stored location of the I-frame.

A still further additional embodiment of the invention provides a system for recording and playing video comprising: a video recorder configured to receive, store and play back video; the video consisting, at least in part, of an unenerypted portion, the unencrypted portion consisting, at least in part, of I-frame location information and an encrypted portion, said encrypted portion consisting, at least in part, of encrypted I-frames, P-frames and B-frames; an I-frame detection module configured to receive the video signal and to detect a predetermined number of encrypted I-frames based on said I-frame location information without de-encrypting the I-frames and a storage module configured to receive and store the predetermined number of encrypted I-frames for use by the video recorder at a predetermined time.

A still her embodiment of the invention provides a system for switching between the display of a first video stream and a second video stream comprising: a stream management module for receiving the first and second video streams, the second video stream consisting, at least in part, of an unencrypted portion, consisting, at least in part, of I-frame location information and a encrypted portion, consisting, at least in part, of encrypted I-frames, P-frames and B-frames; an I-frame detection module configured to receive the second video stream and to detect a predetermined number of encrypted I-frames based on the I-frame location information without de-encrypting the I-frames and a storage module configured to receive and store the encrypted I-frames for use by the stream management module upon switching between the first and second video streams.

Additional embodiments of the invention will be set forth in the description which follows, and in part will become more apparent to those skilled in the art upon examination of the following, or may be learned by practice of the invention.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 shows a generalized digital multimedia encoder;

FIG. 2 shows a generalized digital multimedia scrambler;

FIG. 3A shows the basic structure of several PES packets;

FIG. 3B shows the basic structure of several TS packets;

FIG. 3C shows the basic structure of several encrypted TS packets;

FIG. 4 shows a digital multimedia encoder according to an embodiment of the current invention.

FIG. 5 shows the basic syntax of a TS packet;

FIG. 6 shows a MPEG-2 transport stream, including header and payload according to an embodiment of the current invention;

FIG. 7 shows the how a DVR processes an encrypted video signal according to an embodiment of the current invention;

FIG. 8 shows the processing of I-frames from a plurality of encrypted video streams (e.g. multiple television channels) to accomplish “fast channel switching; according to an embodiment of the current invention;

FIG. 9 shows the processing of a programming video stream and an advertisement programming stream to facilitate “ad insertion” according to an embodiment of the invention; and

FIG. 10 shows the processing of a first programming video stream and an alternative programming stream to facilitate “blackout management” in the instance where the first programming stream is pre-empted for the alternative programming stream according to an embodiment of the invention.

### DESCRIPTION OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In a preferred embodiment of the invention, I-frame location information is generated during encoding and written to a non-encryption portion of the video stream so I-frames can be located quickly and efficiently when needed as in the examples provided above.

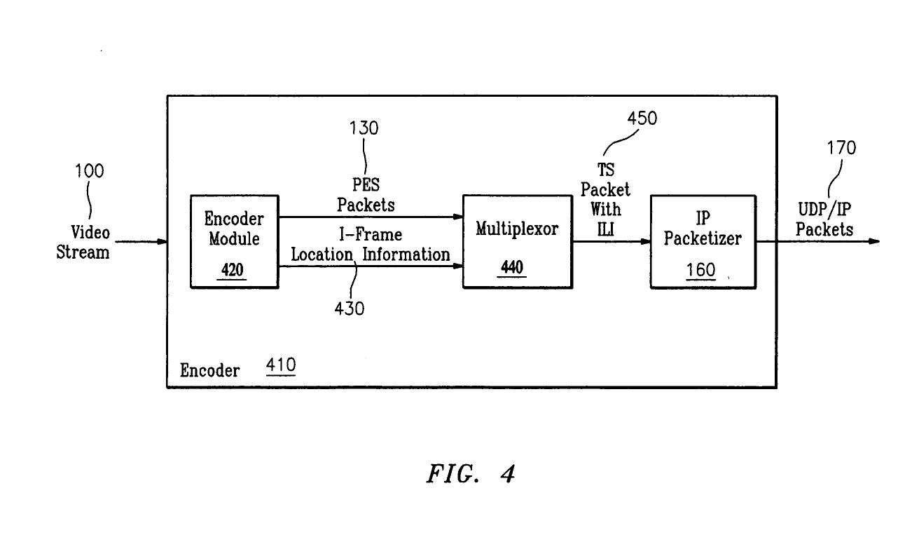

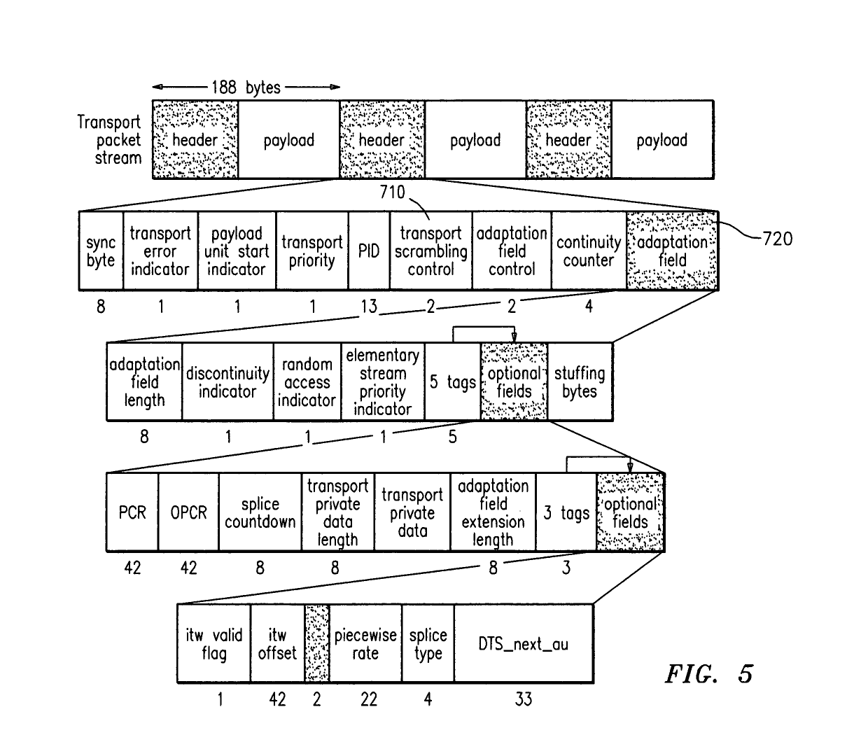

FIG. 4, shows an encoder 410 constructed in accordance with a preferred embodiment of the invention. In a preferred embodiment of the invention, Encoder 410 includes encoder module 420 which encodes video signal 100 using the MPEG-4 AVC standard and generates PES packets including I, B and P frame. Since encoder module 420 generates the frames, encoder module 410 knows the location of each I-frame and can generate I-frame location information 430 (IFI) which it sends with PES packets 130 to multiplexer 440 which generates TS packets 150 and places I-frame location information 430 in TS headers 151 in order to demonstrate whether an I-frame is present in a corresponding PES packet 130 included in such TS packets payload 152. TS packets 150 are transmitted to IP Packetizer 160 which groups seven (7) TS packets 150 into a single UDP/IP (User Datagram Protocol/Internet Protocol) packet 170 to further format the video signal for efficient signal flow through an IP network.

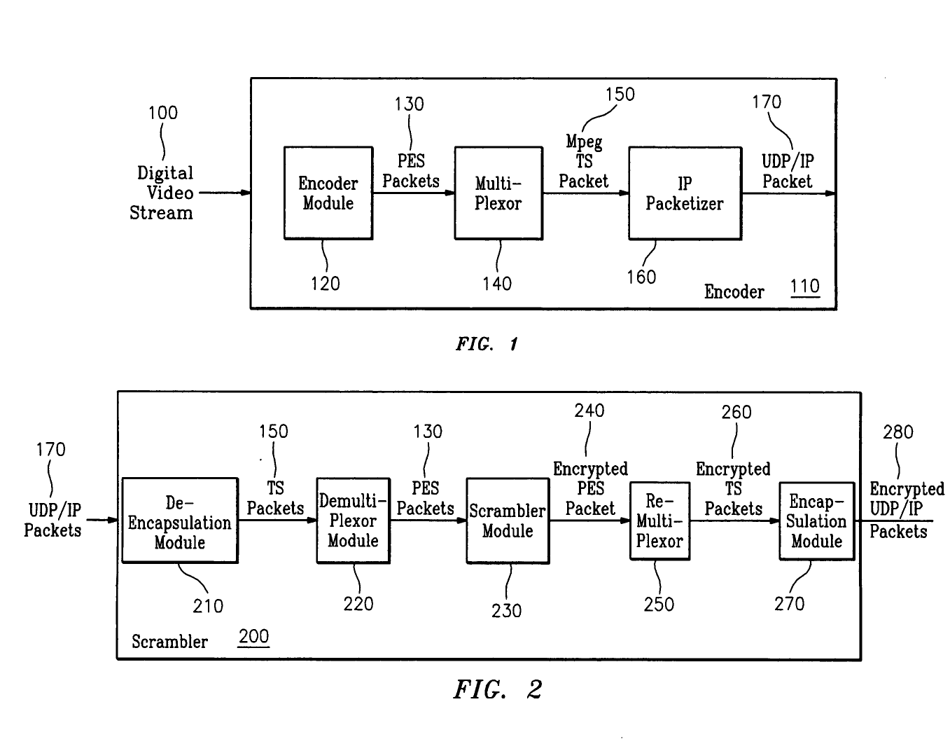

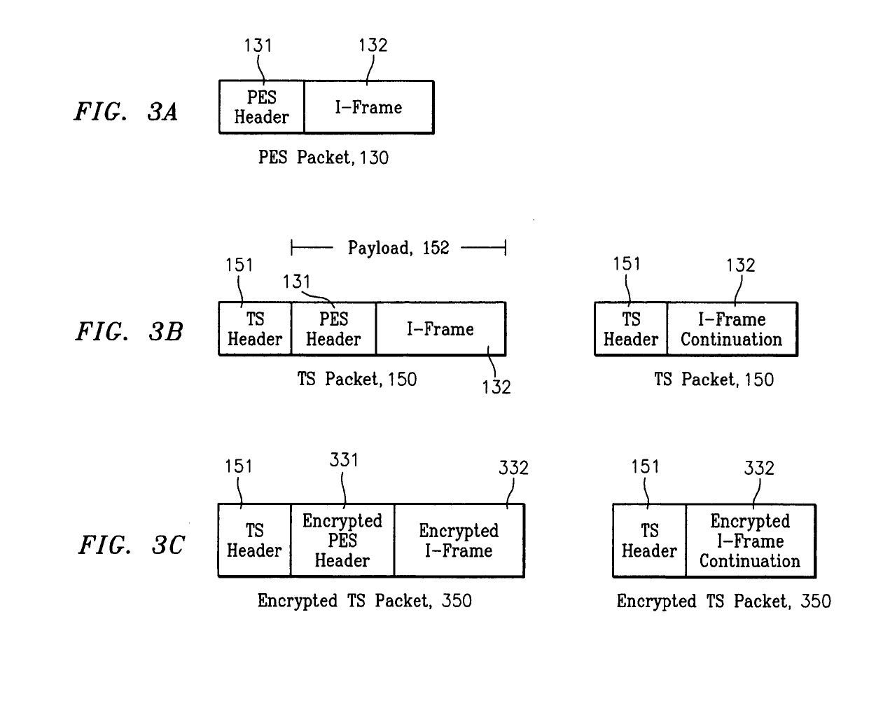

Once encoded, the UDP/IP packets are encrypted before transmission to a viewer utilizing a generalized scrambler such as scrambler 200 shown in FIG. 2. Scrambler 200 encrypts payload 152 but does not encrypt TS header 151 so that encrypted TS packet 350 includes a non-encrypted TS packet header 151 and encrypted payload 152 which includes encrypted PES header 331 and encrypted video frame 332.

Reference is now made to FIG. 5 which shows the syntax of TS header 151. In a preferred embodiment of the invention, the I-frame location information can be stored in transport scrambling control field 710, a two bit field, which is used by the MPEG-2transport control protocol to conveys whether a particular payload is encrypted. When the transport scrambling control field 710 has a value of “00”, the accompanying payload is deemed to be “not scrambled”. The values “01”, “10” and “11” are not mandated by the protocol, but rather are user-defined. As an example, value “10” can be used to designate that no I-frame is present in the payload while value “11” can be used to designate that an I-frame is present. Since I-frame location information 430 is only needed when the I-frame is encrypted, this use of transport scrambling control field 710 does not disturb its intended use since I-frame location information need not be written when transport scrambling control field has a value of “00” designating the payload as unenerypted. Therefore, multiplexer 440 could store an “11” in transport scrambling control field 710 if payload 152 includes I-frame data or a “10” in transport scrambling field 710 if such payload 152 does not include I-frame data. In another embodiment, instead of storing I-frame location information 430 in transport scrambling control field 710, the I-frame location information 430 could be stored in adaptation field 720. The above are provided by example only and it should be appreciated that the I-frame location information can be stored in any non-encrypted field in any transport stream protocol or equivalent non-encrypted portion of a video stream and should not be limited to the MPEG-2 transport stream example provided herein. In addition, one of ordinary skill in the art would be able to construct an encoder (or separate module connected to the encoder) which could capture the I-frame location information and a multiplexer (or separate module connected to the multiplexer) to receive the I-frame location information and write such information to the proper field in TS header 151.

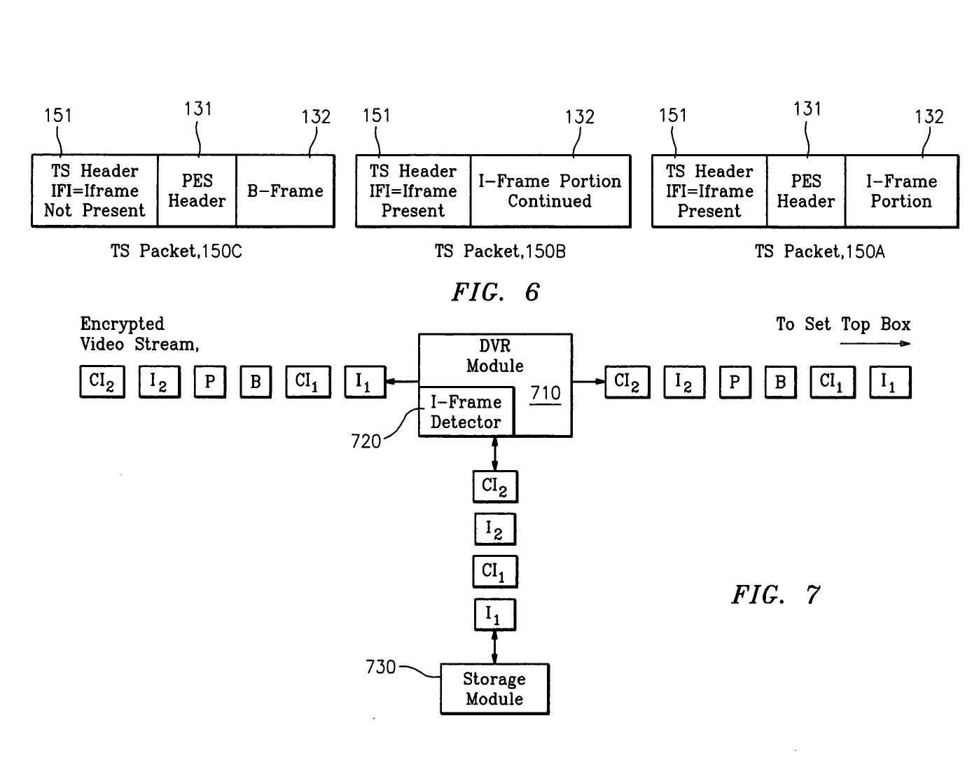

FIG. 6 shows example of several TS packets. Reading from right-to-left, TS packet 150A include a PES header 131, a portion of an I-frame 132 and a TS packet header 151 with I-frame location information 430 set to “I-frame present”. Likewise, TS packet 150B the continuation of the preceding I-frame 132, and a TS packet header 151 with set to I-frame location information 430 set to “I-frame present.” Since TS packet 150B includes the continuation of the prior I-frame, a PES header is not included. Finally, TS packet 150C includes a PES header 131, a B-frame 132 and a TS packet header 151 with I-frame location information 430 set to “I-frame not present”. Since TS headers are not encrypted and thus readable at all times any device at the viewer location or distributor location can locate the I-frame without de-encrypting any PES packets 130 by reading the appropriate field of the TS packet.

Another embodiment of the invention would use a B-frame and P-frame location information representing the presence of a TS header instead the presence of an I-frame. In this embodiment, the decoder would be programmed to recognize B frames and P frames and to ignore those frames when searching for I frames.

In either of these embodiments and as discussed above, various viewing and programming functionality requires location and recognition of I-stream information. The following examples will illustrate how the invention facilitates efficient DVR fast forward and rewind capabilities, fast channel switching, ad insertion and blackout management.

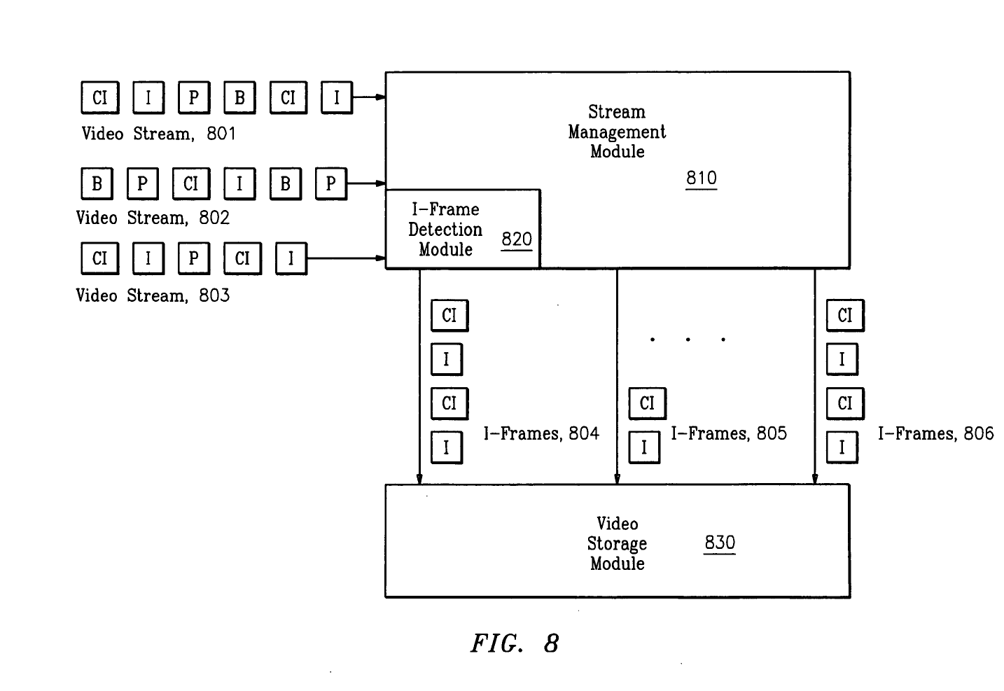

FIG. 7 shows a DVR device 710 which could be either a network DVR located at a third party location such as a head end, or a DVR located either within the set top box or alongside it. The encrypted video signal 705 is received by DVR module 710 and can be recorded for later viewing while still transmitting the video stream to the television in real time. In addition, DVR 710 includes I-frame detection module 720 which reads the TS packet header 151 to determine whether the corresponding PES packet 130 includes an I-frame. I-frame detection module 720 can exist outside of DVR 710 as well. The video frames are shown in FIG. 7 without the headers to better simplify the figure and to better illustrate the flow of the video frames through the system. In actual use, the video frames would include headers and are encoded and encrypted. If an I-frame is present, I-frame detection module 720 instructs DVR 710 to transmit the I-frame to storage module 730 for a predetermined period of time making the I-frames available for use if the viewer elects to fast forward or rewind through a buffered or saved video stream. DVR 710 will be able to transmit only I-frames to the display in order to display an entire undistorted series of frames of video in a fast and efficient manner. This construct allows DVR 710 to quickly locate and store the I-frames since the I-frame location information is not encrypted.

A somewhat similar process takes place in the system shown in FIG. 8 which depicts how “fast channel switching” is performed in an IPTV environment in accordance with the invention. Again, the video frames are shown in FIG. 8 without the headers to simplify the figure and to better illustrate the flow of the video frames through the system. In actual use, the video frames would include headers and are encoded and encrypted. Multiple video streams 801, 802 and 803 (e.g. different channels of programming offered by a programmer/distributor/operator are transmitted to a stream management module 810 located, for example, at a programmer/distributor/operator location. Stream Management module 810 includes I-frame detection module 820 which identifies I-frames in the video signals by reading the TS packet header to determine whether PES packet 130 includes an I-frame, I-frame detection module 820 then directs stream management module 810 to send the I-frames to video storage module 830 for a predetermined period of time. When the set-top box sends a new channel request to the programmer/distributor/operator location requesting a new channel, an I-frame of the requested channel is sent by video storage module 930 via stream management module 810 to the set top box for de-encrypting and display. Again, this is accomplished quickly without having to de-encrypt PES packet header information in order to locate the I-frame which would cause significant delay in displaying the new channel.

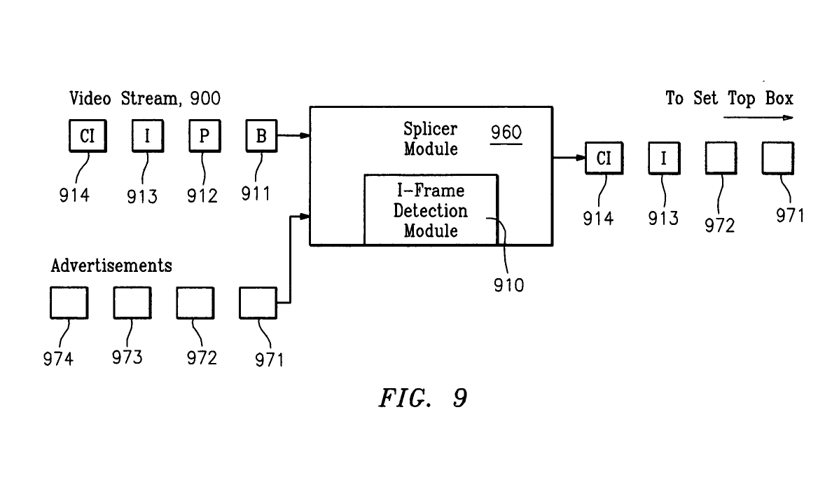

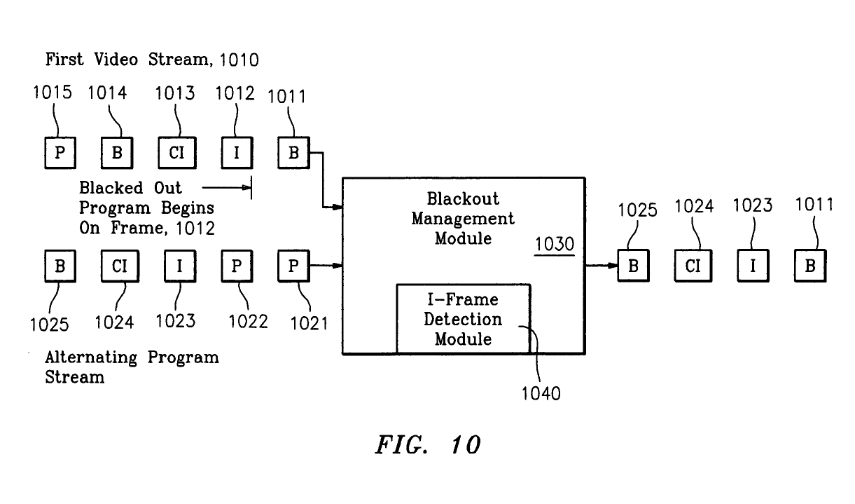

Reference is now made to FIG. 9 which illustrates how a programmer/operator/distributor would insert advertising into an encrypted video stream. As stated above, in order to properly display a complete frame of a program once a commercial ends, an I-frame must be the initial frame displayed or a distorted picture may result if the decoder attempts to decode an initial P or B frame with an inappropriate I-frame, (possibly an I-frame from the commercial). Again, the video frames are shown in FIG. 9 without the headers to simplify the figure and to better illustrate the flow of the video frames through the system. In actual use, the video frames would include headers and are encoded and encrypted. Program stream 900 includes TS packets 911, 912, 913 and 914 which are sent to splicer 960 which inserts the advertisements into video stream 900. In addition, commercials 971, 972, 973 and 974 are also transmitted to splicer 960. I-frame detection module locates the I-frames by reading the appropriate field (e.g. transport scrambling control or adaptation field, for instance) in the TS packet headers in corresponding to frames 911-914 and either stores or forwards to splicing module 960 the location of the I-frames, which in this example are included in TS packets 913 and 914. Splicing module 960 inserts commercials 971 and 972 into program video stream 910 and using the I-frame location information from video management module 950 places TS packet 913 (and the TS packets (914, 915 etc.) that follow after) into the program video stream 910 directly after the commercials so that the segue from commercial back to program does not cause any picture degradation to the viewer.

Similar functionality is shown in FIG. 10 which shows how a programmer/operator/distributor would substitute a second program stream in place of a first program stream when the first program needs to be “blacked out” as discussed above. The video frames are shown in FIG. 10 without the headers to simplify the figure and to better illustrate the flow of the video frames through the system. In actual use, the video frames would include headers and are encoded and encrypted. For example, first program stream 1010 is comprised of TS packets 1011, 1012, 1013, 1014 and 1015. The blacked out video stream begins with the frame included in TS packet 1012. Alternative program video stream 1020 includes TS packets 1021, 1022, 1023, 1024 and 1025. Alternative program stream 1020 is sent to I-frame recognition module 1040 (which can be separate from or included in blackout management module 1030) which locates the I-frames by reading the appropriate field (e.g. transport scrambling control or adaptation field, for instance) in TS packet headers in TS packets 1021-1025 and stores the location of the I-frames which in this example are included in TS packets 1023 and 1024. The blackout management module 1030 switches to alternative programming stream 1020 when directed and begins such stream with TS packet 1023. Blackout management module 1030 thus outputs a video stream consisting of TS packet 1011 (the end of the program preceding the “blacked out program” and TS packets 1023, 1024, 1025 etc. (the beginning of the alternative program stream 1020) which begins with an I-frame in TS packet 1023 thus leading to the display of a complete frame at the beginning of the alternative program.

It should be appreciated that the same process can be employed when the “blacked out” program concludes and the programmer/operator/distributor wishes to resume transmitting first video stream 1010 in which case I-frame detection module 1040 reads the appropriate TS headers in order to locate the I-frame so blackout management module 1030 can properly transmit the I-frame leading to display of a complete frame upon resuming the display of the first program stream.

While the invention herein disclosed has been described by means of specific embodiments and applications thereof, numerous modifications and variations could be made thereto by those skilled in the art without departing from the scope of the invention.

What is claimed is:

1. A method of processing a data stream comprising:
receiving said data stream which includes a first data portion and a second data portion;
locating a data element in said second portion of said data stream; and storing the location of said data element in the first portion of said data stream.

2. The method of claim 1, wherein said first data portion consists, at least in part, of non-encrypted data.

3. The method of claim 2, wherein said second data portion consists, at least in part, of encrypted data.

4. The method of claim 1, wherein said data stream is a video stream and said data element is an I-frame.

5. The method of claim 1, wherein said data stream is a video stream and said data element is one of a B-frame and P-frame.

6. A method of processing a data stream comprising:
receiving said data stream, said data stream consisting, at least in part, of a first data portion and a second data portion, said first data portion consisting, at least in part, of data type location information which signifies a location of a predetermined data type located in said second data portion; and
determining said location of said predetermined data type based on said data type location information.

7. The method of claim 6, wherein said first data portion consists, at least in part, of non-encrypted data.

8. The method of claim 7, wherein said second data portion consists, at least in part, of encrypted data.

9. The method of claim 6, wherein said data stream is a video stream and said predetermined data type is an I-frame.

10. A data encoding apparatus, comprising:
a processing module for receiving data, said data consisting, at least in part, of a first data portion and a second data portion;
a detection module configured to detect a predetermined data type located in said second data portion of said data; and
an encoding module configured to encode, in said first data portion, a location of said predetermined data type.

11. The data encoding apparatus of claim 10, wherein: said data is a video stream, said first data portion consists, at least in part, of non-encrypted data, said second portion consists, at least in part, of encrypted data and said predetermined data type is an I-frame.

12. A data decoding apparatus, comprising:
a processing module configured to receive data, said data consisting, at least in part, of a first data portion and a second data portion, said first data portion consisting, in part, of data type location information which signifies a location of a predetermined data type located in said second data portion; and
a decoding module configured to determine a location of said predetermined data type located in said second data portion utilizing said data type location information.

13. The data decoding apparatus of claim 12 wherein: data is a video stream, said first data portion consisting, at least in part, of non-encrypted data, said second portion consisting, at least in part, of encrypted data, said predetermined data type is an I-frame and said data type location information is unenerypted.

14. A system for processing a video signal, comprising:
an encoder configured to receive said video signal, said video signal, consisting, at least in part, of I-frames, B-frames and P-frames and configured to locate an I-frame in said video signal and to store a location of said I-frame;
an encryption module configured to receive said video signal and to encrypt said I-frames, B-frames and P-frames; and
a decoder configured to receive said encrypted I-frames, B-frames and P-frames and to determine said location of said I-frame utilizing said stored location of said I-frame.

15. A system for recording and playing video comprising:
a video recorder configured to receive and store video; said video consisting, at least in part, of an unencrypted portion, said unencrypted portion consisting, at least in part, of I-frame location information and a encrypted portion, said encrypted portion consisting, at least in part, of encrypted I-frames, P-frames and B-frames;
an I-frame detection module configured to receive said video signal and to detect a predetermined number of said encrypted I-frames based on said I-frame location information without de-encrypting said I-frames; and
a storage module configured to receive and store such predetermined number of said encrypted I-frames for use by said video recorder at a predetermined time.

16. A system for switching between the display of a first video stream and a second video stream comprising:
a stream management module for receiving said first video stream and said second video stream, said second video stream consisting, at least in part, of an unencrypted portion, said unencrypted portion consisting, at least in part, of I-frame location information and a encrypted portion, said encrypted portion consisting, at least in part, of encrypted I-frames, P-frames and B-frames;
an I-frame detection module configured to receive said video signal and to detect a predetermined number of said encrypted I-frames based on said I-frame location information without de-encrypting said I-frames; and
a storage module configured to receive and store such encrypted I-frames for use by said stream management module upon said switching between said first video stream and second video stream.

17. The system of claim 16, wherein said second video stream is an advertisement.
